(19) United States
(12) Patent Application Publication
(10) Pub. No.: US 2013/0322316 A1
(43) Pub. Date: Dec. 5, 2013

(54) WIRELESS COMMUNICATION APPARATUS AND WIRELESS COMMUNICATION METHOD

(71) Applicant: FUJITSU LIMITED, Kawasaki-shi (JP)

(72) Inventors: Yasushi HARA, Yokohama (JP); Katsumi OTSUKA, Kawasaki (JP); Ryosuke OISHI, Kunitachi (JP)

(73) Assignee: FUJITSU LIMITED, Kawasaki-shi (JP)

(21) Appl. No.: 13/962,023

(22) Filed: Aug. 8, 2013

Related U.S. Application Data
(63) Continuation of application No. PCT/JP2011/055763, filed on Mar. 11, 2011.

(51) Int. Cl. H04W 52/02

(52) U.S. Cl. CPC H04W 52/0251
USPC 370/311

(57) ABSTRACT

A wireless communication apparatus has a wireless communication unit and a control unit. The wireless communication unit is connected to a wireless communication network to perform wireless communication. The control unit waits for a stand-by state to be released, and executes stop processing of the wireless communication unit when movement from a service area to an out-of-service area in the wireless communication network has been detected during the stand-by state. Alternatively, the control unit waits for the stand-by state to be released, and executes stop processing of the wireless communication unit when a certain time period has elapsed after the transition to the stand-by state. For example, power supply to the wireless communication unit is stopped.

### CROSS-REFERENCE TO RELATED APPLICATION

This application is a continuation application of International Application PCT/JP2011/055763 filed on Mar. 11, 2011 which designated the U.S., the entire contents of which are incorporated herein by reference.

### FIELD

The embodiments discussed herein are related to a wireless communication apparatus and a wireless communication method.

### BACKGROUND

Currently, widely used are wireless communication apparatuses which perform wireless communication while connected to a wireless communication network such as a mobile communication network and a wireless LAN (Local Area Network). In the wireless communication apparatuses, mobile phones, mobile information terminal apparatuses and the like are included. The wireless communication apparatus sometimes enters a stand-by state for power-saving while not performing data communication and/or information processing in accordance with a user's operation. In the stand-by state, a CPU (Central Processing Unit) terminates an application program, and operates with a low power, for example. The stand-by state is released when events such as a user's operation occur, for example. In addition, the wireless communication apparatus is also able to stop a wireless communication unit which performs radio signal processing (for example, stop power supply to the wireless communication unit).

Besides, with respect to the power-saving of the wireless communication apparatus, a method which stops a digital signal processing unit in an out-of-service area of the wireless communication network and operates a radio wave detection unit periodically, and starts the digital signal processing unit when movement to a service area is recognized by the radio wave detection, has been proposed (for example, see Japanese Laid-open Patent Publication No. 2005-303822). In addition, a method which stops power supply to a transmission and reception unit when a state where data communication is not performed continues for a certain time period, and after that, resumes the power supply to the transmission and reception unit when transmission data is generated has been proposed (for example, see Japanese Laid-open Patent Publication No. 2006-5577).

The wireless communication apparatus is considered to achieve power-saving by stopping the wireless communication unit such as stopping power supply to the wireless communication unit. However, when stop processing of the wireless communication unit occurs during a stand-by state, an overhead will become a problem. For example, when an application program is executed for stop processing, a CPU which has been in a stand-by state starts the application program, and when the stop processing is completed, terminates the application program after confirming that there are no other information processing to be executed. In this case, in addition to a power consumption corresponding to the stop processing, a power consumption corresponding to the overhead for starting and terminating the application program occurs. Therefore, when stop processing of the wireless communication unit occurs during a stand-by state, a consumed power may increase on the contrary.

### SUMMARY

According to an aspect of the present embodiment, there is provided a wireless communication apparatus, including: a wireless communication unit connected to a wireless communication network and configured to perform wireless communication; and a control unit configured to, when the wireless communication apparatus transitions to a stand-by state without stopping the wireless communication unit and movement from a service area to an out-of-service area in the wireless communication network is detected during the stand-by state, wait for the stand-by state to be released, and to execute stop processing of the wireless communication unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a wireless communication apparatus according to a first embodiment;

FIG. 2 illustrates a wireless communication system according to a second embodiment;

FIG. 3 is a block diagram illustrating an example of hardware of a terminal apparatus;

FIG. 4 is a block diagram illustrating a function of a terminal apparatus according to the second embodiment;

FIG. 5 is a flowchart illustrating a stand-by control according to the second embodiment;

FIG. 6 is a flowchart illustrating a stand-by release according to the second embodiment;

FIG. 7 illustrates a first changing example of a consumed power in the terminal apparatus;

FIG. 8 illustrates a second changing example of a consumed power in the terminal apparatus;

FIG. 9 illustrates another changing example of a consumed power in the terminal apparatus;

FIG. 10 illustrates a structural example of a beacon frame;

FIG. 11 is a flowchart illustrating a stand-by control according to a third embodiment;

FIG. 12 illustrates a third changing example of a consumed power in the terminal apparatus;

FIG. 13 illustrates a fourth changing example of a consumed power in the terminal apparatus;

FIG. 14 is a block diagram illustrating a function of a terminal apparatus according to a fourth embodiment;

FIG. 15 is a sequence diagram illustrating a communication example between virtual machines according to the fourth embodiment; and

FIG. 16 illustrates a fifth changing example of a consumed power in the terminal apparatus.

### DESCRIPTION OF EMBODIMENTS

Several embodiments will be described below with reference to the accompanying drawings, wherein like reference numerals refer to like elements throughout.

### First Embodiment

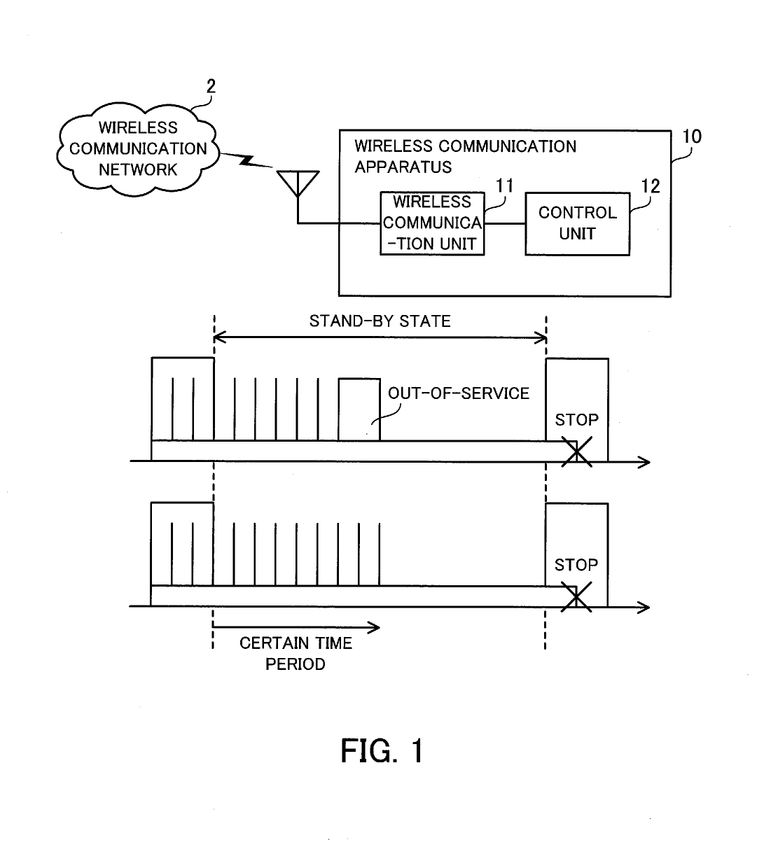

FIG. 1 illustrates a wireless communication apparatus according to a first embodiment. A wireless communication apparatus 10 according to the first embodiment performs wireless communication using a wireless communication network 2. As the wireless communication apparatus 10, a mobile wireless communication apparatus (mobile station) such as a mobile phone and/or a mobile information terminal apparatus is used, for example. The wireless communication apparatus 10 has a wireless communication unit 11 and a control unit 12.

The wireless communication unit 11 is connected to the wireless communication network 2, and performs wireless communication. For example, the wireless communication unit 11 performs radio signal processing including modulation and demodulation and/or encoding and decoding. As the wireless communication network 2, a wireless LAN is able to be used, for example. In that case, the wireless communication unit 11 is connected to an access point of the wireless LAN, and receives continuously a beacon signal which the access point transmits. However, the wireless communication network 2 may be a network other than the wireless LAN.

The control unit 12 controls the wireless communication unit 11. The control unit 12 may be realized using a computer provided with a CPU and a RAM (Random Access Memory). Here, considered is a case where the wireless communication apparatus 10 has transitioned to a stand-by state without stopping the wireless communication unit 11. When movement from a service area to an out-of-service area in the wireless communication network 2 has been detected during a stand-by state, the control unit 12 waits for the stand-by state to be released, and executes stop processing of the wireless communication unit 11. In addition, when a certain time period has elapsed after transition to the stand-by state, the control unit 12 waits for the stand-by state to be released, and executes stop processing of the wireless communication unit 11.

Besides, by stop processing of the wireless communication unit 11, power supply to the wireless communication unit 11 may be stopped. For example, the wireless communication apparatus 10 may have a power controller which stops power supply to the wireless communication unit 11 when the control unit 12 executes stop processing. In addition, the stand-by state may be released by a user's operation. For example, the control unit 12 may detect the stand-by release by detecting a user's operation such as a key input and/or opening and closing of a housing. After the stand-by release, an application program for screen display is started, for example. In addition, movement to the out-of-service area may be detected based on a reception status of a radio signal in the wireless communication unit 11.

In addition, until the stand-by state is released after a certain time period has elapsed after movement to the out-of-service area has been detected (or, after movement to the out-of-service area has been detected), the control unit 12 may control the wireless communication unit 11 so that the wireless communication unit does not perform searching (also referred to as search or scan) of an access point of the wireless communication network 2. In addition, the control unit 12, until a stand-by state is released after a certain time period has elapsed after the transition to the stand-by state, may control the wireless communication unit 11 so that the wireless communication unit 11 does not perform processing to receive a radio signal from an access point of the wireless communication network 2. In addition, the control unit 12 may execute only one of processing when the above-mentioned movement to the out-of-service area is detected and processing when a certain time period has elapsed after the transition to the stand-by state.

The wireless communication apparatus 10 transitions to a stand-by state without stopping the wireless communication unit 11. When movement from the service area to the out-of-service area in the wireless communication network 2 has been detected during a stand-by state, the stand-by release is waited for, and stop processing of the wireless communication unit 11 is executed. Alternatively, when a certain time period has elapsed after the transition to the stand-by state, the stand-by release is waited for, and stop processing of the wireless communication unit is executed.

Thereby, a power consumption accompanying the control of the wireless communication unit 11 is able to be suppressed. For example, when an application program is executed for stop processing of the wireless communication unit 11, an overhead of starting and terminating the application program is able to be suppressed as compared with a case where stop processing is executed without waiting for the stand-by state to be released. Consequently, a consumed power corresponding to the overhead is suppressed, and power-saving of the wireless communication apparatus 10 is achieved. In addition, by the wireless communication unit 11 stopping searching of the access point after the movement to the out-of-service area has been detected, a consumed power is able to be suppressed furthermore. In addition, by the wireless communication unit 11 stopping reception processing after a certain time period has elapsed after the transition to the stand-by state, a consumed power is able to be suppressed furthermore.

### Second Embodiment

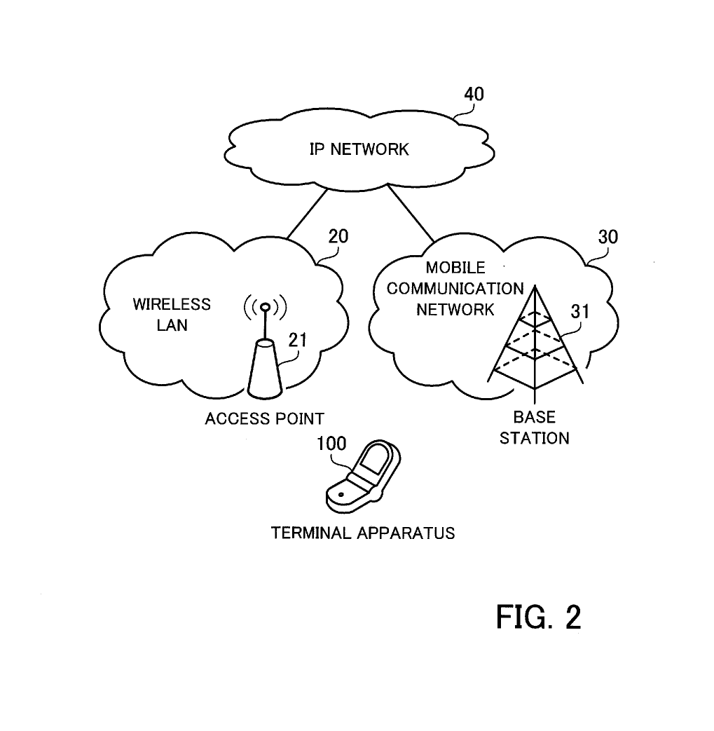

FIG. 2 illustrates a wireless communication system according to a second embodiment. The wireless communication system according to the second embodiment includes a wireless LAN 20, a mobile communication network 30, an IP (Internet Protocol) network 40 and a terminal apparatus 100.

The wireless LAN 20 is a LAN provided with a wireless interface. The wireless LAN 20 is an example of the wireless communication network 2 according to the first embodiment. The wireless LAN 20 is connected to the IP network 40 which transmits an IP packet, and transfers data between the terminal apparatus 100 and the IP network 40. The wireless LAN 20 includes an access point 21. The access point 21 is a wireless communication apparatus which performs communication wirelessly with the terminal apparatus 100, and performs communication via a cable with a communication apparatus on the side of the IP network 40. For a wireless communication system, IEEE (The Institute of Electrical and Electronics Engineers) 802.11 is used for example. The access point 21 transmits periodically a beacon frame including parameters of communication setting.

The mobile communication network 30 is a network provided with a wireless interface. The mobile communication network 30 is connected to the IP network 40 in the same way as the wireless LAN 20, and transfers data between the terminal apparatus 100 and the IP network 40. The mobile communication network 30 includes a base station 31. The base station 31 is a wireless communication apparatus which performs communication wirelessly with the terminal apparatus 100, and performs communication via a cable with a communication apparatus on the side of the IP network 40. For the wireless communication system, a different system from the wireless LAN 20 such as the W-CDMA (Wideband Code Division Multiple Access) and/or the LTE (Long Term Evolution) is used for example.

The terminal apparatus 100 is a mobile wireless communication apparatus which performs wireless communication using the wireless LAN 20 and the mobile communication network 30, and is a mobile phone and/or a mobile information terminal apparatus or the like, for example. The terminal apparatus 100 is an example of the wireless communication apparatus 10 according to the first embodiment. The terminal apparatus 100 scans an access point of the wireless LAN 20, and is connected to the wireless LAN 20 via the access point 21. In addition, the terminal apparatus 100 scans a base station of the mobile communication network 30, and is connected to the mobile communication network 30 via the base station 31. The terminal apparatus 100 includes at least two types of wireless interfaces, and is able to maintain connection with either or both of the wireless LAN 20 and the mobile communication network 30.

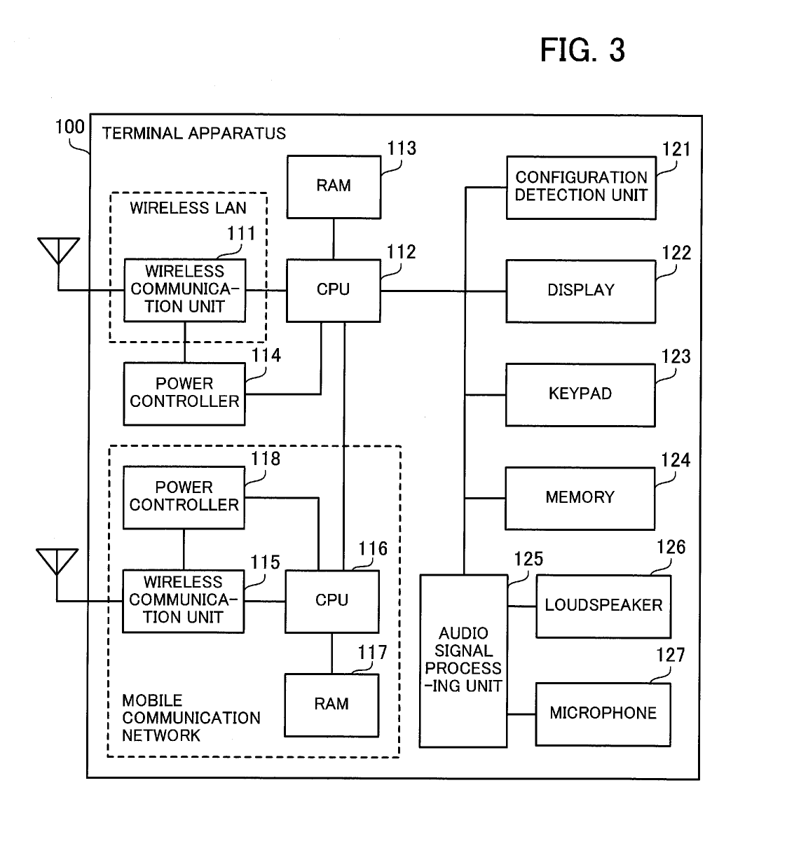

FIG. 3 is a block diagram illustrating an example of hardware of the terminal apparatus. The terminal apparatus 100 has wireless communication units 111 and 115, CPUs 112 and 116, RAMs 113 and 117, power controllers 114 and 118, a configuration detection unit 121, a display 122, a keypad 123, a memory 124, an audio signal processing unit 125, a loudspeaker 126 and a microphone 127.

The wireless communication unit 111 performs wireless communication with the access point 21 in accordance with a communication standard (IEEE 802.11, for example) of the wireless LAN 20. The wireless communication unit 111 is an example of the wireless communication unit 11 according to the first embodiment. The wireless communication unit 111 demodulates and error-correction-decodes a radio signal received by an antenna, and outputs extracted data to the CPU 112, for example. In addition, the wireless communication unit 111 error-correction-encodes and modulates data acquired from the CPU 112, and outputs the radio signal from the antenna. The wireless communication unit 111 receives the beacon frame periodically as a general rule during operation even during a state (idle state) in which data communication is not performed.

The CPU 112 controls an operation of the terminal apparatus 100, such as wireless communication and/or screen display. The CPU 112 reads at least a part of programs and/or data stored in the memory 124 to develop it to the RAM 113. Then, the CPU 112 executes an OS (Operating System) program and/or a driver program, and executes an application program on the OS. For example, the CPU 112 accesses the wireless communication unit 111 and/or the display 122 in accordance with the driver program. In addition, in accordance with the application program, the CPU 112 performs processing such as connection with and disconnect from the wireless LAN 20 and/or screen display of the display 122.

In states of the CPU 112, an active state (active state), an idle state and a stand-by state are included. The CPU 112, in the active state, executes information processing in accordance with the application program. In the idle state, the CPU 112 runs the application program, but does not execute information processing (waits for information processing). In the stand-by state, the CPU 112 does not run the application program, and operates with a low power. When transitioning to the stand-by state, the CPU 112 turns off a screen display of the display 122 (stops output of an image signal to the display 122), and terminates the application program. In addition, when releasing the stand-by state by a user's operation, the CPU 112 starts the application program to turn on the screen display.

The RAM 113 is a volatile memory which stores temporarily programs and data read by the CPU 112. However, the terminal apparatus 100 may include a memory of a type other than a RAM. The CPU 112 and RAM 113 is an example of the control unit 12 according to the first embodiment.

The power controller 114 controls under a control of the CPU 112 power supply to the wireless communication unit 111 and CPU 112 from a battery which the terminal apparatus 100 includes. When the wireless communication unit 111 is in an idle state, the power controller 114 decreases a power supplied to the wireless communication unit 111. However, when the wireless communication unit 111 receives a beacon frame, and/or scans an access point, the power controller 114 increases temporarily the power supplied to the wireless communication unit 111. When the wireless communication unit 111 is stopped, the power controller 114 stops power supply to the wireless communication unit 111. In addition, the power controller 114, during a stand-by state, decreases a power supplied to the CPU 112.

The wireless communication unit 115 performs wireless communication with the base station 31 in accordance with a communication standard (W-CDMA and LTE, for example) of the mobile communication network 30. The wireless communication unit 115 demodulates and error-correction-decodes a signal received by an antenna, and outputs a digital baseband (DBB: Digital Baseband) signal to a CPU 116, for example. In addition, the wireless communication unit 115 error-correction-encodes and modulates a DBB signal acquired from the CPU 116, and outputs a radio signal from the antenna. As an antenna for the mobile communication network 30, a different antenna from the antenna for the wireless LAN 20 may be used. The wireless communication unit 115 performs synchronous communication periodically with the base station 31 during a stand-by state.

The CPU 116 processes a DBB signal with respect to the mobile communication network 30. The CPU 116 processes the DBB signal acquired from the wireless communication unit 115, and outputs the extracted reception data to the CPU 112. In addition, the CPU 116 processes transmission data acquired from the CPU 112, and outputs the DBB signal to the wireless communication unit 115. The CPU 112 develops to the RAM 113 at least a part of programs and data which are used for the DBB processing, and executes the programs.

The RAM 117 is a volatile memory which stores temporarily programs which the CPU 116 executes and/or data used for the DBB processing. However, the terminal apparatus 100 may include a memory of a type other than a RAM.

The power controller 118 controls under a control of the CPU 116 power supply to the wireless communication unit 115 and CPU 116 from a battery which the terminal apparatus 100 includes. The power controller 118, during a stand-by state, decreases a power supplied to the wireless communication unit 115 and the CPU 116. However, when the wireless communication unit 115 performs synchronous communication with the base station 31, the power controller 118 increases temporarily the power supplied to the wireless communication unit 115.

The configuration detection unit 121 detects that a configuration of a housing of the terminal apparatus 100 has changed by a user's operation. For example, when the housing of the terminal apparatus 100 is slidable, the configuration detection unit 121 detects that a user has slid the housing. In addition, when the housing of the terminal apparatus 100 is openable and closable, the configuration detection unit 121 detects that a user has opened or closed the housing. Besides, the configuration change of the housing is detectable using a means such as a switch having a projecting shape which detects a contacting state between housings, a magnetic sensor which detects a magnetic force of a magnet embedded in the housing, and an infrared sensor which detects positional relationship between housings, for example.

The display 122 displays a screen in accordance with an image signal acquired from the CPU 112. As the display 122, a liquid crystal display and/or an organic electroluminescence (Electro Luminescence) display or the like is able to be used, for example.

The keypad 123 includes a plurality of input keys. When any input key is depressed by a user, the keypad 123 outputs an input signal indicating the depressed input key to the CPU 112. Besides, the terminal apparatus 100 may include a touch panel which detects a touch operation on the display 122.

The memory 124 is a nonvolatile memory which stores programs and data used for processing of the CPU 112. As the memory 124, a flash memory is able to be used, for example. In programs to be stored, an OS program, driver programs corresponding to devices which the terminal apparatus 100 includes, and application programs and the like are included.

The audio signal processing unit 125 performs under a control of the CPU 112 audio signal processing. The audio signal processing unit 125 processes digital audio data acquired from the CPU 112, and outputs the audio signal to the loudspeaker 126. In addition, the audio signal processing unit 125 processes an audio signal acquired from the microphone 127 to output the processed audio signal as digital audio data to the CPU 112.

The loudspeaker 126 converts an electrical signal as the audio signal acquired from the audio signal processing unit 125 into a physical vibration to reproduce a sound. For example, when a user is performing a call, the voice of the communication partner and background noises are output from the loudspeaker 126.

The microphone 127 accepts an audio input by converting a physical vibration of a sound into an electrical signal, and outputs the electrical signal as the audio signal to the audio signal processing unit 125. For example, when a user is performing a call, the user's voice and background noises are input from the microphone 127.

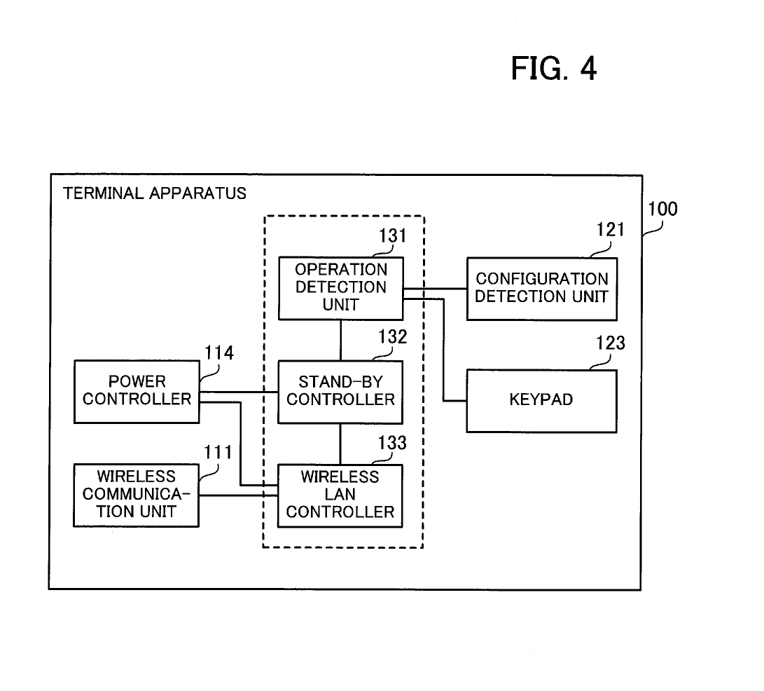

FIG. 4 is a block diagram illustrating a function of a terminal apparatus according to the second embodiment. The terminal apparatus 100 has an operation detection unit 131, a stand-by controller 132 and a wireless LAN controller 133. The operation detection unit 131, stand-by controller 132 and wireless LAN controller 133 are implemented as program modules which the CPU 112 executes, for example. However, implementing as hardware circuits is also possible.

The operation detection unit 131, during a stand-by state, detects a user's operation to turn on a screen display. For example, the operation detection unit 131 accepts from the configuration detection unit 121 a notification indicating that an operation of opening a housing of the terminal apparatus 100 has been performed. In addition, the operation detection unit 131 accepts from the keypad 123 a notification indicating that a key of the keypad 123 has been depressed. In addition, the operation detection unit 131 detects a user's operation to turn off the screen display. For example, the operation detection unit 131 accepts from the configuration detection unit 121 a notification indicating that an operation to close a housing of the terminal apparatus 100 has been performed. The notification to the operation detection unit 131 is realizable as an interrupt signal to the CPU 112, for example.

The stand-by controller 132 controls transition to and release from a stand-by state. When the operation detection unit 131 detects a user's operation to turn off the screen display, or an idle state of the CPU 112 continues during a certain time period, the stand-by controller 132 determines transition to the stand-by state. When transitioning to the stand-by state, the stand-by controller 132 carries out control so that an application program is terminated and a screen display is turned off and instructs the power controller 114 to suppress power supply. In addition, the stand-by controller 132, when the operation detection unit 131 detects a user's operation to turn on the screen display, carries out control so that an application program is started and the screen display is turned on.

The wireless LAN controller 133 controls an operation of the wireless communication unit 111. The wireless LAN controller 133, when the wireless communication unit 111 detects movement of the wireless LAN 20 to the out-of-service area, makes the wireless communication unit 111 execute scanning periodically until a certain time period (for example, 15 minutes) elapses or an access point is detected. The movement to the out-of-service area is detected when a reception level of a radio signal from the access point 21 becomes less than a threshold value, for example. In addition, the wireless LAN controller 133, when stopping utilization of the wireless LAN 20, executes stop processing, and instructs the power controller 114 to stop power supply to the wireless communication unit 111. In the stop processing, releasing of an IP address assigned from the wireless LAN 20, and/or rewriting of configuring information to be kept are included, for example.

In addition, the wireless LAN controller 133, in transitioning to a stand-by state without stopping the wireless communication unit 111, configures the wireless communication unit 111 so as to stop receiving of a beacon frame when a certain time period (for example, 15 minutes) elapses after the stand-by start. In addition, the wireless LAN controller 133, when a stand-by state is released, makes the wireless communication unit 111 execute scanning of an access point, and when an access point is not able to be discovered, performs stop processing of the wireless communication unit 111. Besides, as stated later, the wireless LAN controller 133, during a stand-by state, does not execute stop processing.

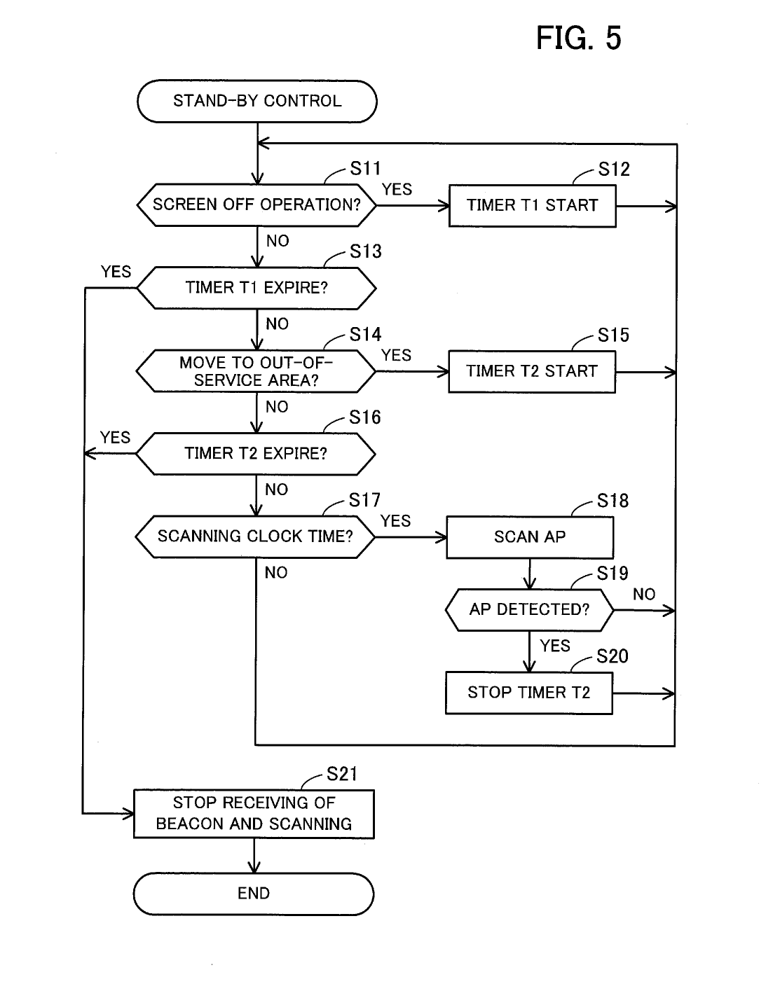

FIG. 5 is a flowchart illustrating a stand-by control according to the second embodiment. Here, considered is a case where an idle state is made to be kept without stopping the wireless communication unit 111 also during a stand-by state. Hereinafter, processing illustrated in FIG. 5 will be described along with the step numbers.

(Step S11) The CPU 112 determines whether a user's operation (for example, an operation to close a housing) to turn off a screen display is detected. When the user's operation is detected, the process proceeds to step S12. When the user's operation is not detected, the process proceeds to step S13.

(Step S12) The CPU 112 configures a timer T1 (for example, a timer for 15 minutes) in the wireless communication unit 111. The wireless communication unit 111 starts counting of the timer T1 configured from the CPU 112. The CPU 112 terminates an application program and transitions to a stand-by state. The power controller 114 decreases a power to be supplied to the CPU 112. Then, the process proceeds to step S11.

Besides, the wireless communication unit 111, in place of the detection based on the timer T1 configured from the CPU 112, may detect elapsing of a certain time period by counting reception times of a beacon frame received from the access point 21 periodically. In addition, the CPU 112 may carry out control so that a timer device of the outside of the wireless communication unit 111 may be used, and after elapsing of the certain time period, the timer expiration may be notified of from the timer device to the wireless communication unit 111.

(Step S13) The wireless communication unit 111 determines whether the timer T1 has expired (alternatively, whether reception times of a beacon frame has reached prescribed number of times after the stand-by start). When the timer T1 has not expired, the process proceeds to step S14. When the timer T1 has expired, the process proceeds to step S21.

(Step S14) The wireless communication unit 111 determines whether the terminal apparatus 100 has moved to an out-of-service area of the wireless LAN 20 (for example, whether a reception level of a beacon frame has become lower than a threshold value). When the terminal apparatus 100 is determined to have moved to the out-of-service area, receiving of a beacon frame is stopped, and the process proceeds to step S15. When the terminal apparatus 100 is determined to be in the service area, the process proceeds to step S16.

(Step S15) The CPU 112, when movement to the out-of-service area is notified of from the wireless communication unit 111, executes an out-of-service transition process. In the out-of-service transition process, deleting of an IP address assigned by a DHCP (Dynamic Host Configuration Protocol) and/or selecting of an access point to be scanned are included, for example. Information on an available access point (for example, identification information of an access point) is stored in the memory 124 in advance.

In addition, in the out-of-service transition process, starting of a timer T2 (for example, a timer for 15 minutes) is included. In addition, the CPU 112 carries out configuring to execute scanning of an access point periodically. For example, by use of a timer device, the wireless LAN controller 133 is made to be executed at a clock time at which scanning is performed and at a timing at which the timer T2 expires. However, the wireless communication unit 111 may manage the scanning clock time and the timer T2. For example, the CPU 112 may configure the timer T2 in the wireless communication unit 111. Then, the process proceeds to step S11.

(Step S16) The CPU 112 (alternatively, the wireless communication unit 111) determines whether the timer T2 has expired. When the timer T2 has not expired, the process proceeds to step S17. When the timer T2 has expired, the process proceeds to step S21.

(Step S17) The CPU 112 (alternatively, the wireless communication unit 111) determines whether the scanning clock time has come. When the scanning clock time has come, the process proceeds to step S18. When the scanning clock time has not come, the process proceeds to step S11.

(Step S18) The wireless communication unit 111 checks whether communication with an access point selected by the out-of-service transition process is possible under a control of the CPU 112. The wireless communication unit 111 performs scanning by means of an active system, for example. When using the active system, the wireless communication unit 111 wirelessly transmits the identification information of the access point to be scanned, and when the response is returned, determines that the access point corresponding to the identification information has been detected. However, the wireless communication unit 111 may perform scanning by means of a passive system. In scanning, the power controller 114 increases a power to be supplied to the wireless communication unit 111.

(Step S19) The wireless communication unit 111 determines whether an access point that provides a radio signal having a reception level of not less than a threshold value has been detected by the scanning. When such an access point has been detected, the process proceeds to step S20. When such an access point has not been detected, the process proceeds to step S11.

(Step S20) The CPU 112 controls the wireless communication unit 111 so as to be connected to the detected access point, and performs processing such as acquiring an IP address by means of the DHCP. The wireless communication unit 111 checks parameters included in a beacon frame, and receives the beacon frame at a period in accordance with the parameters. In addition, the CPU 112 (alternatively, the wireless communication unit 111) stops the timer T2. Then, the process proceeds to step S11.

(Step S21) When the timer T1 has expired, the wireless communication unit 111 stops the receiving of the beacon frame. When the timer T2 has expired, the wireless communication unit 111 and the CPU 112 stop scan processing. After that, until the stand-by state is released, receiving of the beacon frame and scanning are not executed. However, the CPU 112 does not perform stop processing of the wireless communication unit 111. The power controller 114 supplies the wireless communication unit 111 with the minimum current (base current) to maintain the idle state. The CPU 112 waits for the stand-by state to be released.

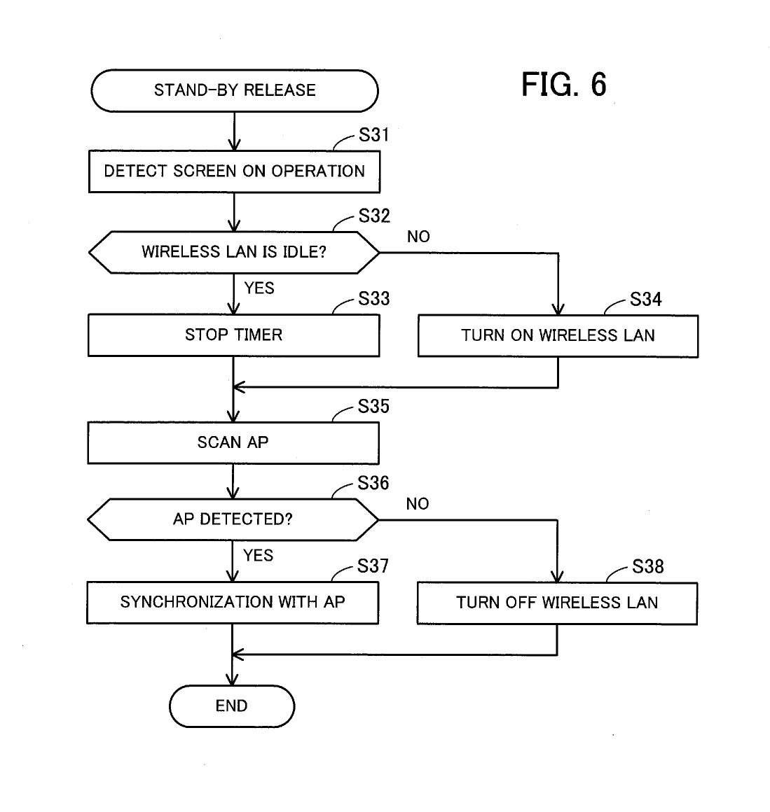

FIG. 6 is a flowchart illustrating stand-by release according to the second embodiment. When the stand-by state is released, the process is stopped even in the middle of the process illustrated in FIG. 5, and the process illustrated in FIG. 6 is executed. Hereinafter, a process illustrated in FIG. 6 will be described along with the step numbers.

(Step S31) The CPU 112 detects a user's operation to turn on a screen display (for example, an operation to open a housing, a key input or the like). The power controller 114 increases a power to be supplied to the CPU 112, and the CPU 112 starts an application program. Thereby, the CPU 112 transitions to an active state.

(Step S32) The CPU 112 determines whether the wireless communication unit 111 operates in an idle state. When the wireless communication unit 111 operates in an idle state, the process proceeds to step S33. When the wireless communication unit 111 has stopped (for example, when stop processing of the wireless communication unit 111 has been performed before transition to the stand-by state), the process proceeds to step S34.

(Step S33) When a timer which is operating exists among the above-mentioned timers T1 and T2, the CPU 112 stops the timer. Then, the process proceeds to step S35.

(Step S34) The CPU 112 instructs the power controller 114 to restart power supply from the power controller 114 to the wireless communication unit 111 (turn on the wireless LAN).

(Step S35) The CPU 112 selects an access point to be scanned, and instructs the wireless communication unit 111 to scan the access point. The wireless communication unit 111 checks whether communication with the access point specified from the CPU 112 is possible.

(Step S36) The wireless communication unit 111 determines whether an access point that provides a radio signal having a reception level of not less than a threshold value has been detected by the scanning. When such an access point has been detected, the process proceeds to step S37. When an access point has not been detected, the process proceeds to step S38.

(Step S37) The CPU 112 controls the wireless communication unit 111 so as to be connected to the detected access point, and performs processing such as acquiring an IP address by means of the DHCP. The wireless communication unit 111 checks parameters included in a beacon frame, and receives the beacon frame at a period in accordance with the parameters.

(Step S38) The CPU 112 executes stop processing of the wireless communication unit 111. In the stop processing, releasing of an IP address assigned from the wireless LAN 20, and/or rewriting of configuring information to be kept are included, for example. The CPU 112 instructs the power controller 114 to stop power supply from the power controller 114 to the wireless communication unit 111 (turn off the wireless LAN).

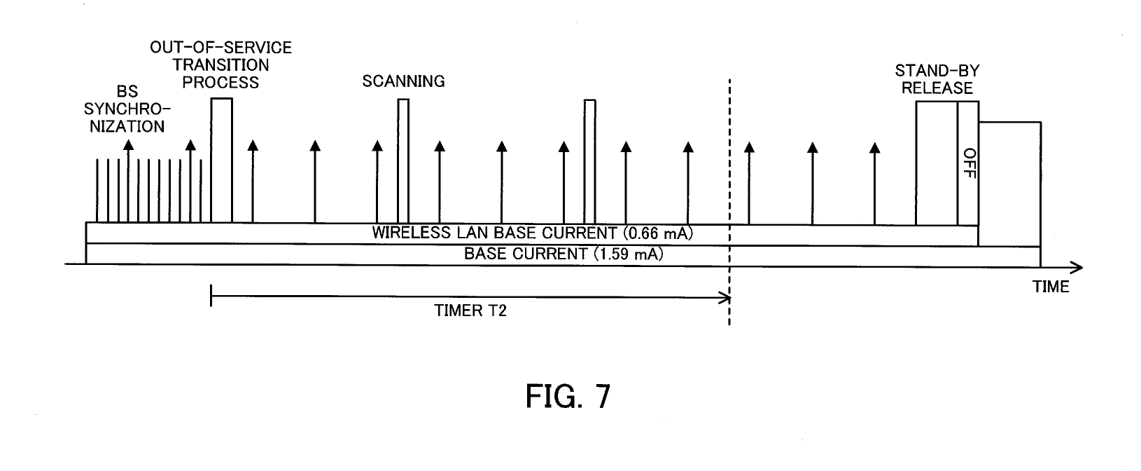

FIG. 7 illustrates a first changing example of a consumed power in a terminal apparatus. Here, considered is a case where the CPU 112 transitions to a stand-by state without stopping the wireless communication unit 111, and the terminal apparatus 100 has moved to an out-of-service area of the wireless LAN 20 during the stand-by state.

During the stand-by state, the terminal apparatus 100 consumes a base current (for example, 1.59 mA) for operating the CPU 112 and the power controllers 114 and 118. In addition, the terminal apparatus 100 consumes a wireless LAN base current (for example, 0.66 mA) for operating the wireless communication unit 111. In addition, the terminal apparatus 100, periodically (for example, at every one second and/or every 100 milliseconds), operates the wireless communication unit 111 and the power controller 114, and receives a beacon frame from the access point 21 to consume a power. In addition, the terminal apparatus 100, periodically (for example, at every 2.56 seconds), operates the wireless communication unit 115 and the power controller 118, and performs synchronous communication with the base station 31 to consume a power.

When having moved from a service area to an out-of-service area of the wireless LAN 20 during a stand-by state, the terminal apparatus 100 stops the receiving of a beacon frame, and performs an out-of-service transition process, and starts periodical scanning of an access point. When the out-of-service transition process and the scanning are carried out, the wireless communication unit 111, the CPU 112 and the power controller 114 operate temporarily to consume a power. When the timer T2 expires (for example, 15 minutes elapses since the out-of-service transition process) without an access point being detected, the terminal apparatus 100 stops scanning, and leaves the wireless communication unit 111 as is in an idle state.

When a user's operation to turn on a screen display is performed, the terminal apparatus 100 operates the CPU 112 and the power controller 114, and transitions from a stand-by state to an active state. Then, the terminal apparatus 100, when confirming to be in the out-of-service area of the wireless LAN 20, operates the CPU 112 and the power controller 114, and performs stop processing of the wireless communication unit 111. Thereby, supplying of the wireless LAN base current from the power controller 114 to the wireless communication unit 111 is stopped. When performing data communication, the terminal apparatus 100 operates the wireless communication unit 115, the CPU 116 and the power controller 118, and accesses the base station 31 of the mobile communication network 30.

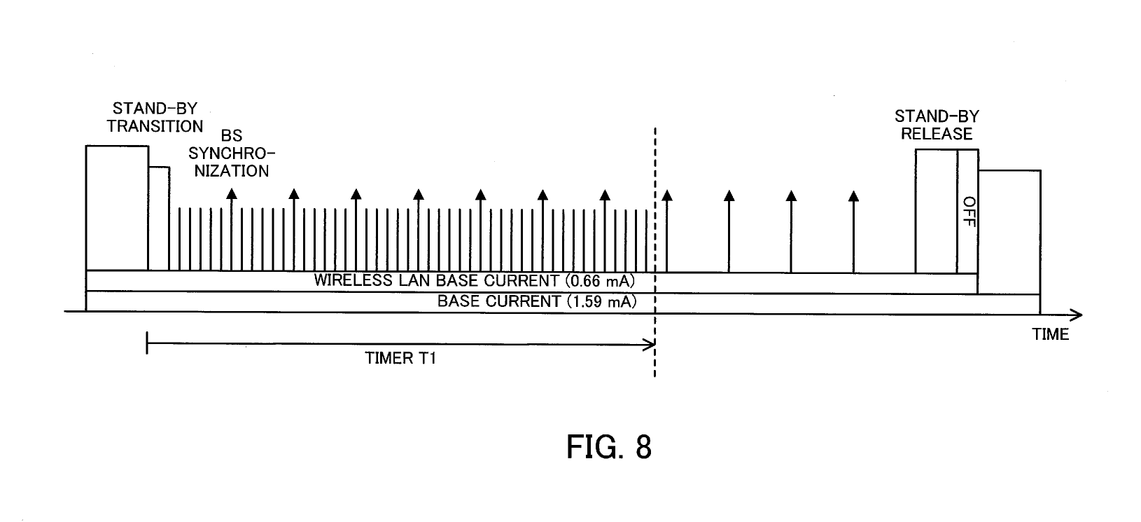

FIG. 8 illustrates a second changing example of a consumed power in a terminal apparatus. Here, considered is a case where the CPU 112 transitions to a stand-by state without stopping the wireless communication unit 111, and the stand-by state is maintained for not less than a certain time period while the terminal apparatus 100 stays in the service area of the wireless LAN 20.

When a user's operation to turn off a screen display is performed, the terminal apparatus 100 transitions from an active state to an idle state, and while operating the CPU 112 and the power controller 114, transitions to a stand-by state. As mentioned above, during a stand-by state, the terminal apparatus 100 consumes a base current and a wireless LAN base current. In addition, the terminal apparatus 100, while receiving a beacon frame periodically from the access point 21, performs synchronous communication periodically with the base station 31 to consume a power.

When the timer T1 expires (for example, 15 minutes elapses since transitioning to the stand-by state), the wireless communication unit 111 stops the receiving of a beacon frame. The timing at which the timer T1 is started may be a time point at which a user's operation to turn off a screen display is performed and the CPU 112 transitions to an idle state, or may be just before the transitioning to the stand-by state. The CPU 112 leaves the wireless communication unit 111 as is in an idle state.

When a user's operation to turn on a screen display is performed, the terminal apparatus 100 operates the CPU 112 and the power controller 114, and transitions from a stand-by state to an active state. Then, the terminal apparatus 100, when detecting that the terminal apparatus 100 has moved to the out-of-service area of the wireless LAN 20 while stopping the receiving of a beacon frame, operates the CPU 112 and the power controller 114, and performs stop processing of the wireless communication unit 111. Thereby, supplying of the wireless LAN base current from the power controller 114 to the wireless communication unit 111 is stopped.

Next, a consumed power of the terminal apparatus 100 when the terminal apparatus 100 is assumed to have executed stop processing of the wireless communication unit 111 during a stand-by state will be described.

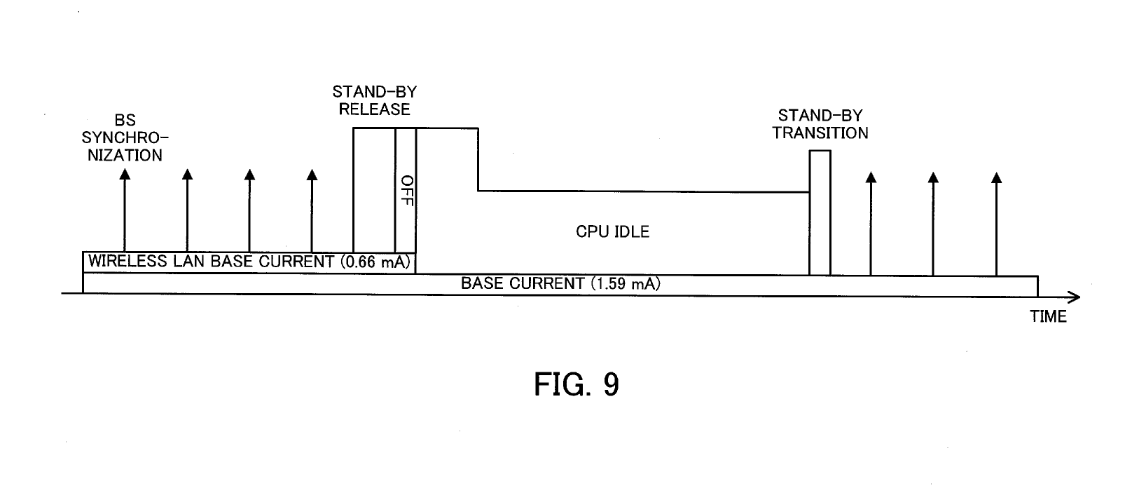

FIG. 9 illustrates another changing example of a consumed power in a terminal apparatus. Here, considered is a case where the CPU 112 transitions to a stand-by state without stopping the wireless communication unit 111 and the terminal apparatus 100 moves to an out-of-service area of the wireless LAN 20 during a stand-by state, or a stand-by state is maintained for not less than a certain time period while the terminal apparatus 100 stays in a service area of the wireless LAN 20.

When a certain time period elapses after the movement to the out-of-service area of the wireless LAN 20 during the stand-by state, or a certain time period elapses after the stand-by start, the terminal apparatus 100 operates the CPU 112 and the power controller 114, and starts an application program. Thereby, the CPU 112 transitions from a stand-by state to an active state. The terminal apparatus 100 performs stop processing of the wireless communication unit 111 in accordance with the application program. Thereby, supplying of a wireless LAN base current from the power controller 114 to the wireless communication unit 111 is stopped.

When the stop processing is completed, the CPU 112, while an application program enters a processing waiting state, transitions from an active state to an idle state. The terminal apparatus 100 confirms that there are no other information processing to be executed in accordance with the application program (for example, detects that the CPU 112 is in an idle state for a certain time period continuously), and operates the CPU 112 and the power controller 114, and transitions to a stand-by state again.

In this way, when the terminal apparatus 100 performs stop processing of the wireless communication unit 111 during a stand-by state, an overhead occurs after the CPU 112 has transitioned from the stand-by state to the active state until the CPU 112 returns to the stand-by state again via an idle state. Therefore, while a consumed power corresponding to a wireless LAN base current is able to be reduced, a consumed power corresponding to the overhead will increase.

According to the terminal apparatus 100 of the second embodiment, a consumed power accompanying control of the wireless communication unit 111 is able to be suppressed. The terminal apparatus 100 is able to suppress an overhead of starting and terminating the application program as compared with a case where the stop processing is executed during a stand-by state. Therefore, the consumed power corresponding to the overhead is suppressed, and power-saving of the terminal apparatus 100 is achieved. In addition, the terminal apparatus 100 stops scanning of an access point after the movement to the out-of-service area has been detected, and thereby the consumed power is able to be suppressed. In addition, the terminal apparatus 100 stops receiving of the beacon frame after a certain time period has elapsed after the stand-by start, and thereby the consumed power is able to be suppressed.

### Third Embodiment

Next, a third embodiment will be described. Descriptions will be provided centering around differences from the second embodiment, and with respect to the same matters as the second embodiment, descriptions will be omitted.

A terminal apparatus according to the third embodiment selects during a stand-by state whether to maintain a connection with a wireless LAN based on parameters which an access point transmits. A wireless communication system according to the third embodiment is able to be realized by the same system configuration as in FIG. 2. The terminal apparatus according to the third embodiment is able to be realized by the same hardware configuration as in FIG. 3. Hereinafter, the third embodiment will be described using the same symbols as in FIGS. 2 and 3.

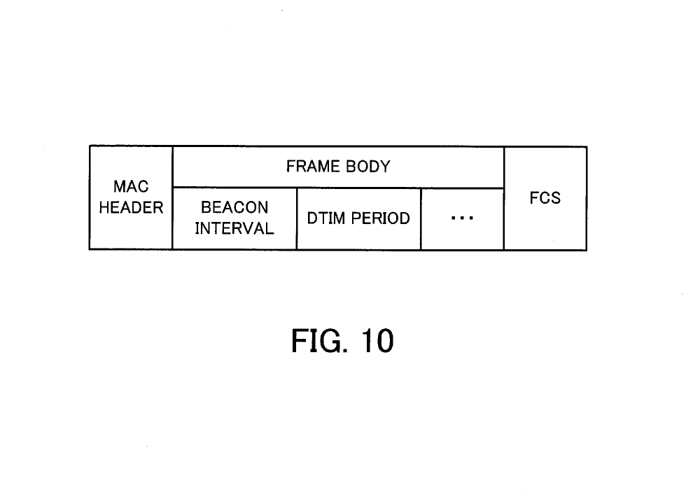

FIG. 10 illustrates a structural example of a beacon frame. The beacon frame as illustrated in FIG. 10 is transmitted periodically (for example, at every 100 milliseconds) from an access point 21. The beacon frame includes a MAC (Media Access Control) header, a frame body and an FCS (Frame Check Sequence).

The MAC header is a header of a MAC layer added to the frame. The frame body is a data part of the frame. The FCS is a check bit used for error detection of the frame. The frame body includes parameters such as a beacon interval and a DTIM (Delivery Traffic Indication Message) period. Values of the parameters transmitted by the beacon frame are configured in the access point 21 in advance. The beacon interval indicates a transmission interval of the beacon frame. The DTIM period indicates an interval of beacon frames to be at least received by the terminal apparatus 100 among transmitted beacon frames.

For example, when the beacon interval is 100 milliseconds and the DTIM period is 10, the terminal apparatus 100 receives the beacon frame at least once in one second which is equal to 100 millisecond multiplied by 10. The values of the above-mentioned parameters may change depending on access points. The terminal apparatus 100 controls a receiving interval of the beacon frame in accordance with values of parameters included in the beacon frame which the access point of connection destination transmits.

Meanwhile, when the terminal apparatus 100 is connected to the wireless LAN 20 or the mobile communication network 30, an IP address is assigned to the terminal apparatus 100 from the wireless LAN 20 or the mobile communication network 30. When the IP address is able to be specified, a message is able to be transmitted from the IP network 40 side to the terminal apparatus 100 even when there is not an access from the terminal apparatus 100. Consequently, while an IP address is assigned, the terminal apparatus 100 is able to use a service (so-called push type service) by which a message addressed to the terminal apparatus 100 is able to be acquired passively. However, the mobile communication network 30 may release the assignment of the IP address when the terminal apparatus 100 does not perform data communication via the mobile communication network 30 continuously for a certain time period.

Then, the terminal apparatus 100 is considered to select and execute any of the following two stand-by methods in order to maintain the assignment of the IP address also during a stand-by state. A first method maintains the IP address assigned from the mobile communication network 30 by performing data communication periodically (for example, at every 28 minutes) with a server apparatus in the IP network 40 via the mobile communication network 30. In the first method, the terminal apparatus 100 may release a connection with the wireless LAN 20. A second method maintains the IP address assigned from the wireless LAN 20 by maintaining a connection with the wireless LAN 20 and continuing receiving of the beacon frame. In the second method, the terminal apparatus 100 needs not perform the periodical data communication via the mobile communication network 30.

For the purpose of power-saving, the terminal apparatus 100 selects, from the above-mentioned two stand-by methods, the one whose consumed power will become lower. Which one becomes lower in the consumed power depends on a period in which the beacon frame is received from the wireless LAN 20. When a reception period of the beacon frame is short, a consumed power in the second method becomes larger, and selecting the first method becomes more advantageous. On the other hand, when a reception period of the beacon frame is long, a consumed power in the second method becomes smaller, and selecting the second method becomes more advantageous. Then, the terminal apparatus 100 selects a stand-by method based on values of parameters included in the beacon frame received from the access point 21.

For example, the terminal apparatus 100 selects the first method when the DTIM period is less than a threshold value, and selects the second method when the DTIM period is not less than the threshold value. Alternatively, the terminal apparatus 100 selects the first method when the reception period calculated from the DTIM period and beacon interval is less than a threshold value, and selects the second method when the calculated reception period is not less than the threshold value. Alternatively, the terminal apparatus 100 selects the first method when an estimated consumed power calculated from the DTIM period and beacon interval exceeds a threshold value, and selects the second method when the estimated consumed power is not more than the threshold value. The threshold value information used for the determination is stored in the memory 124 in advance, for example.

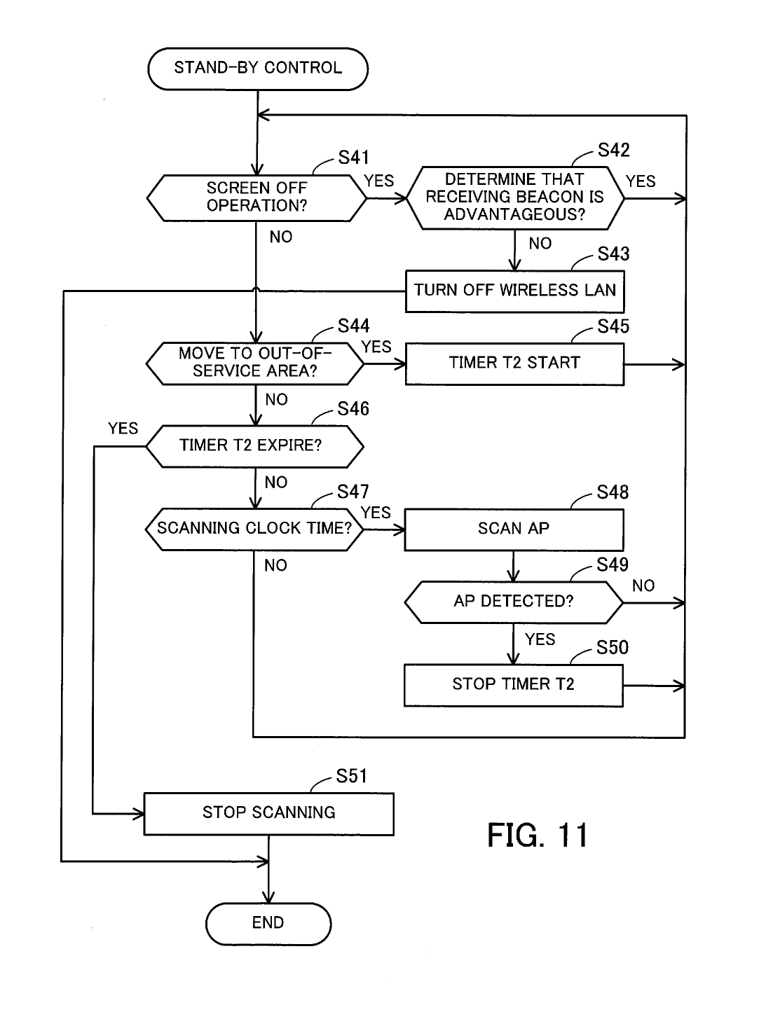

FIG. 11 is a flowchart illustrating a stand-by control according to the third embodiment. Since processes of steps S44 to S50 of FIG. 11 are the same as steps S14 to S20 of the second embodiment illustrated in FIG. 5, descriptions are omitted.

(Step S41) The CPU 112 determines whether a user's operation to turn off a screen display has been detected. When the user's operation is detected, the process proceeds to step S42. When the user's operation is not detected, the process proceeds to step S44.

(Step S42) The CPU 112, based on parameters acquired from the access point 21, determines whether continuing receiving of a beacon frame is more advantageous in respect of a consumed power (whether the above-mentioned second method is selected as a stand-by method). When the continuing receiving of a beacon frame is determined to be advantageous, the CPU 112 transitions to a stand-by state, and the process proceeds to step S41. In this case, the wireless communication unit 111 maintains the receiving of a beacon frame until the stand-by state is released, or the terminal apparatus 100 moves to the out-of-service area. On the other hand, when the continuing receiving of a beacon frame is determined to be disadvantageous, the process proceeds to step S43. Note that, a stand-by method may be selected when the terminal apparatus 100 is connected to the access point 21.

(Step S43) The CPU 112, before the transitioning to a stand-by state, executes stop processing of the wireless communication unit 111. The power controller 114 stops power supply to the wireless communication unit 111 (wireless LAN is turned off). The CPU 112 terminates an application program and transitions to a stand-by state. The wireless communication unit 115 performs data communication periodically (for example, at every 28 minutes) during a stand-by state.

(Step S51) When the timer T2 expires, the wireless communication unit 111 and the CPU 112 stop scan processing. After that, the wireless communication unit 111 does not execute receiving of a beacon frame and scanning. The wireless communication unit 115 performs data communication periodically.

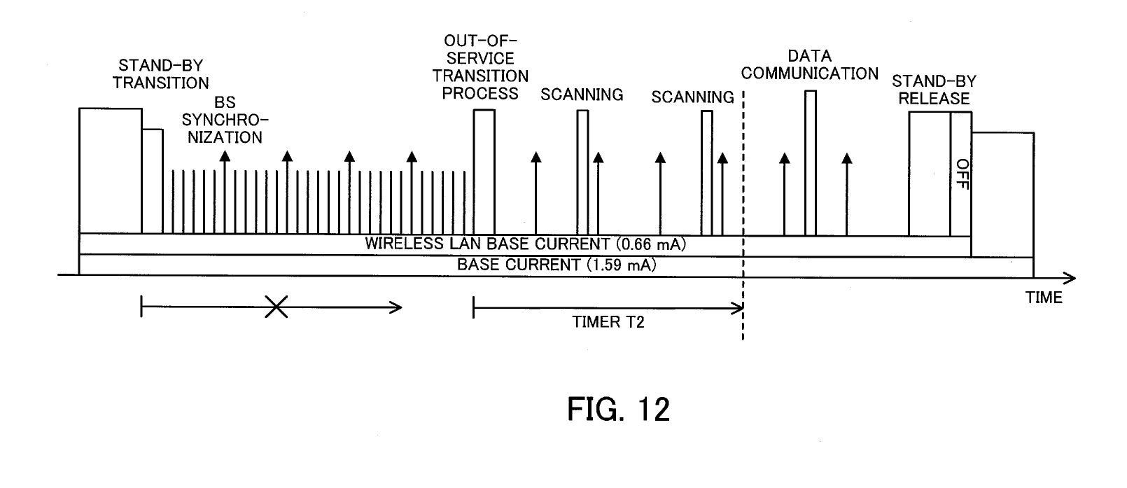

FIG. 12 illustrates a third changing example of a consumed power in a terminal apparatus. Here, considered is a case where the terminal apparatus 100 selects a stand-by method in which a connection with the wireless LAN 20 is maintained also during a stand-by state, and moves to the out-of-service area of the wireless LAN 20 during the stand-by state.

When a user's operation to turn off a screen display is performed, the terminal apparatus 100 transitions from an active state to a stand-by state via an idle state. During the stand-by state, the terminal apparatus 100 consumes a base current and a wireless LAN base current. The terminal apparatus 100 receives a beacon frame periodically (for example, at every one second) from the access point 21, and performs synchronous communication periodically (for example, at every 2.56 seconds) with the base station 31. Even when a certain time period (the time of the timer T1 described in the second embodiment) elapses after the stand-by start, the terminal apparatus 100 does not stop receiving of a beacon frame.

When moving to the out-of-service area of the wireless LAN 20 during the stand-by state, the terminal apparatus 100 stops the receiving of the beacon frame, performs an out-of-service transition process, and starts periodical scanning of an access point. When the timer T2 expires (for example, 15 minutes elapses since the out-of-service transition process) without an access point being detected, the terminal apparatus 100 stops scanning, and leaves the wireless communication unit 111 as is in an idle state. In addition, the terminal apparatus 100, after stopping of scanning, performs data communication periodically (for example, at every 28 minutes) with a prescribed server apparatus via the mobile communication network 30 in order to receive an assignment of an IP address from the mobile communication network 30 and maintain the IP address.

When a user's operation to turn on a screen display is performed, the terminal apparatus 100 transitions from a stand-by state to an active state. Then, the terminal apparatus 100 confirms that the terminal apparatus 100 is in the out-of-service area of the wireless LAN 20, and performs stop processing of the wireless communication unit 111. Thereby, supplying of a wireless LAN base current from the power controller 114 to the wireless communication unit 111 is stopped. When performing data communication, the terminal apparatus 100 performs communication with the base station 31 of the mobile communication network 30. Note that, in the above-mentioned description, the periodical data communication via the mobile communication network 30 is assumed to be started after stopping of scanning, but may be started when movement to the out-of-service area of the wireless LAN 20 is detected.

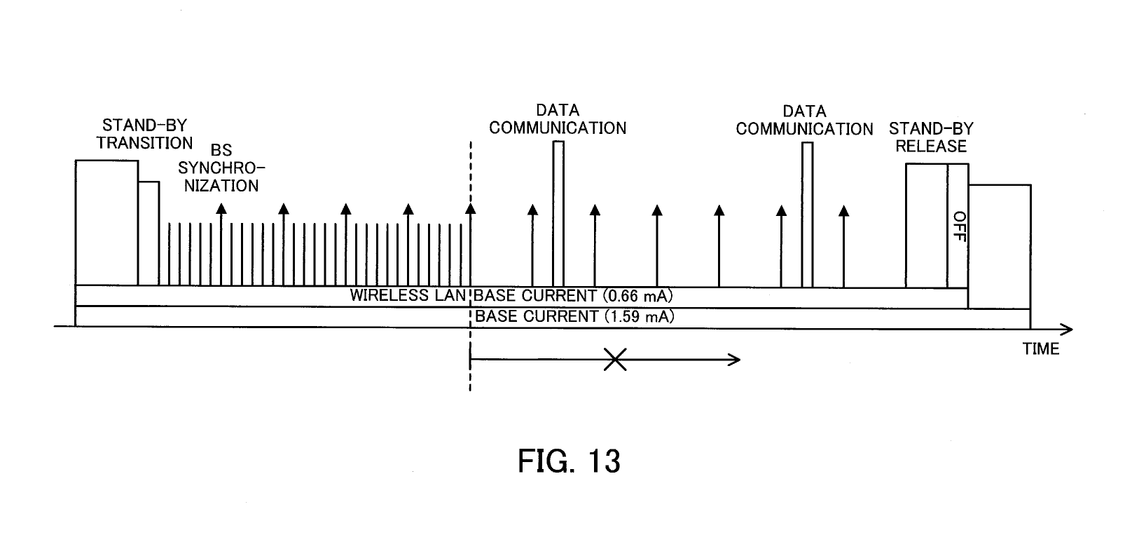

FIG. 13 illustrates a fourth changing example of a consumed power in a terminal apparatus. In the above-mentioned description, the terminal apparatus 100 is assumed to execute scanning of an access point after the movement to the out-of-service area until the timer T2 expires, but scanning may not be executed.

When moving to the out-of-service area of the wireless LAN 20 during a stand-by state, the terminal apparatus 100 stops receiving of a beacon frame, does not perform scanning of an access point, and leaves the wireless communication unit 111 as is in an idle state. The terminal apparatus 100 performs data communication periodically with a prescribed server apparatus via the mobile communication network 30 in order to receive an assignment of an IP address from the mobile communication network 30 and maintain the IP address. When a user's operation to turn on a screen display is performed, the terminal apparatus 100 confirms that the terminal apparatus 100 is in the out-of-service area of the wireless LAN 20, and performs stop processing of the wireless communication unit 111.

According to the terminal apparatus 100 of the third embodiment, in the same way as in the second embodiment, a consumed power accompanying control of the wireless communication unit 111 is able to be suppressed. In addition, the terminal apparatus 100, as a stand-by method in which an IP address is able to be maintained, is able to select a method in which the consumed power is smaller, and is able to achieve power-saving. In addition, the terminal apparatus 100 does not perform scanning of an access point when having moved to the out-of-service area of the wireless LAN 20 during a stand-by state, and thereby the terminal apparatus 100 is able to switch a stand-by method promptly.

### Fourth Embodiment

Next, a fourth embodiment will be described. Descriptions will be provided centering around differences from the second embodiment, and with respect to the same matters as the second embodiment, descriptions will be omitted.

A terminal apparatus according to the fourth embodiment executes a plurality of OSs using a virtualization technology. A wireless communication system according to the fourth embodiment is able to be realized by the same system configuration as in FIG. 2. The terminal apparatus according to the fourth embodiment is able to be realized by the same hardware configuration as in FIG. 3.

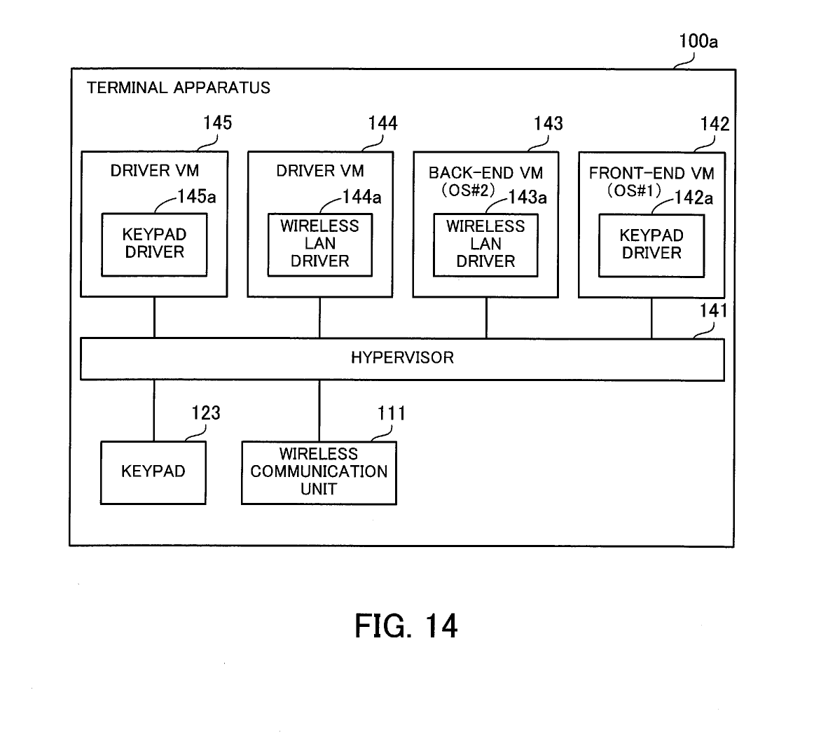

FIG. 14 is a block diagram illustrating a function of a terminal apparatus according to the fourth embodiment. A terminal apparatus 100a according to the fourth embodiment has a hypervisor 141, a front-end VM (Virtual Machine) 142, a back-end VM 143 and drivers VM 144 and 145. The hypervisor 141 and a plurality of virtual machines (VM) are implemented as program modules which the CPU 112 executes, for example.

The hypervisor 141 controls a plurality of virtual machines. The hypervisor 141 manages hardware resources such as the CPU 112 and the RAM 113, and assigns hardware resources to a plurality of virtual machines. In addition, the hypervisor 141 relays communication between virtual machines, and/or communication between devices such as the wireless communication unit 111 and/or the keypad 123, and virtual machines.

The front-end VM 142 is a virtual machine for the purpose of user interface control (front-end control). On the front-end VM 142, an OS #1 is executed. The front-end VM 142 controls ON/OFF of a screen display of the display 122. The front-end VM 142 has a keypad driver 142a. The keypad driver 142a accepts a key input via the driver VM 145.

The back-end VM 143 is a virtual machine for the purpose of control (back-end control) of a process performed in a background of the user interface. On the back-end VM 143, an OS #2 is executed. The back-end VM 143 has a wireless LAN driver 143a. The wireless LAN driver 143a controls the wireless communication unit 111 via the driver VM 144.

The driver VM 144 is a virtual machine to execute a driver program for the purpose of accessing devices which the back-end VM 143 controls. The driver VM 144 has a wireless LAN driver 144a. The wireless LAN driver 144a, in accordance with an instruction from the back-end VM 143, transmits a command to the wireless communication unit 111 via the hypervisor 141. In addition, the wireless LAN driver 144a, when accepting a notification of a key input from the driver VM 145, transfers the notification to the back-end VM 143. The driver VM 145 is a virtual machine to execute a driver program for the purpose of accessing devices which the front-end VM 142 controls. The driver VM 145 has a keypad driver 145a. The keypad driver 145a, via the hypervisor 141, acquires an input signal which the keypad 123 outputs, and notifies the front-end VM 142 of the key input. In addition, when a key input is performed during a stand-by state, the keypad driver 145a notifies also the driver VM 144 of the key input.

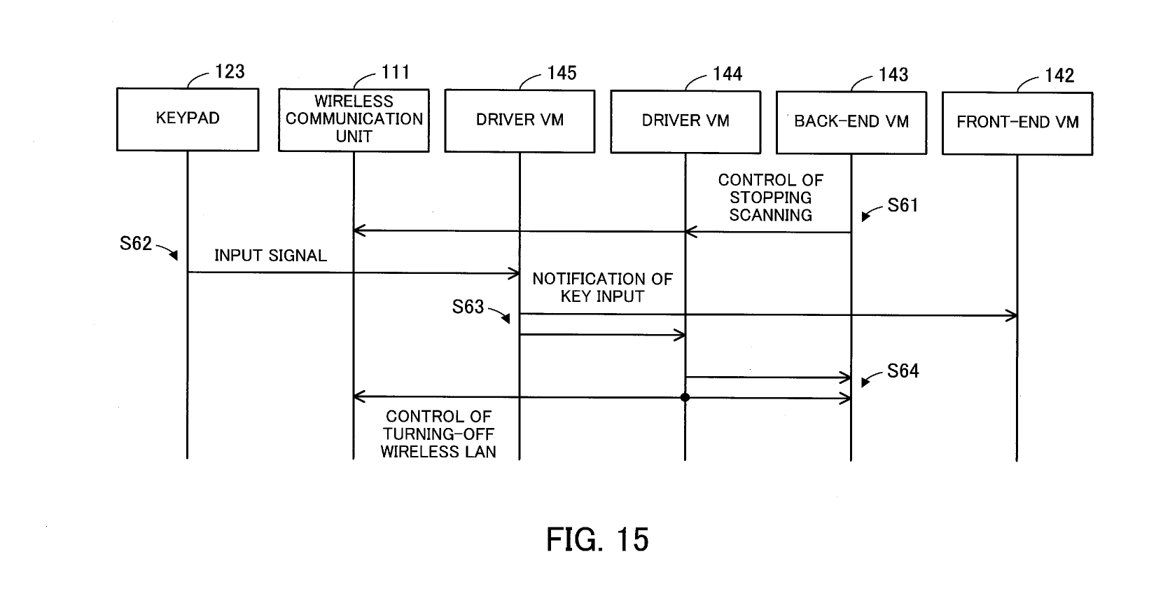

FIG. 15 is a sequence diagram illustrating a communication example between virtual machines according to the fourth embodiment. Here, considered is a case where the terminal apparatus 100a moves to the out-of-service area of the wireless LAN 20 during a stand-by state, and the timer T2 has expired while the terminal apparatus 100a is not able to discover an access point. Hereinafter, sequences illustrated in FIG. 15 will be described along with the step numbers.

(Step S61) The back-end VM 143 instructs the driver VM 144 to stop scanning. The driver VM 144 transmits a command to the wireless communication unit 111 via the hypervisor 141 to stop scanning. Thereby, the wireless communication unit 111 maintains an idle state without performing receiving of a beacon frame and scanning.

(Step S62) The keypad 123, when detecting a user's key operation, transmits an input signal indicating the depressed key to the driver VM 145 via the hypervisor 141.

(Step S63) The driver VM 145 transmits a notification of the key input to the front-end VM 142 via the hypervisor 141. The front-end VM 142 starts an application program, and turns on a screen display of the display 122. In addition, the driver VM 145 transmits a notification of the key input to the driver VM 144.

(Step S64) The driver VM 144 transmits a notification of the key input to the back-end VM 143 via the hypervisor 141. The back-end VM 143 recognizes that the notification of the key input is an event which will trigger releasing a stand-by state of the front end, and controls ON/OFF of the wireless communication unit 111. Thereby, when the terminal apparatus 100a stays in the out-of-service area of the wireless LAN 20, stop processing of the wireless communication unit 111 is executed.

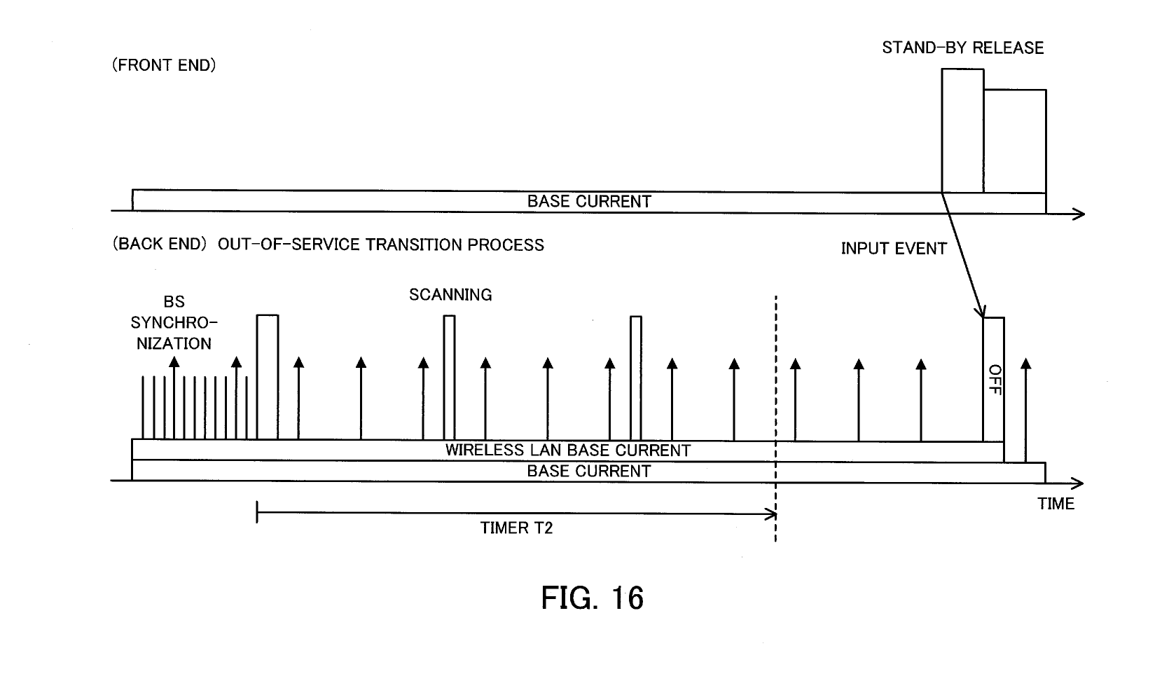

FIG. 16 illustrates a fifth changing example of a consumed power in a terminal apparatus.

After the stand-by start, the terminal apparatus 100a consumes a base current for maintaining the OS #1 of the front-end VM 142 and the OS #2 of the back-end VM 143. In addition, the terminal apparatus 100a consumes a wireless LAN base current for operating the wireless communication unit 111.

When the terminal apparatus 100a moves to the out-of-service area of the wireless LAN 20 during a stand-by state, the back-end VM 143 performs an out-of-service transition process, and makes the wireless communication unit 111 execute scanning periodically. When the timer T2 expires without an access point being detected, the wireless communication unit 111 stops scan processing.

When a user's operation to turn on a screen display is performed, the front-end VM 142 detects the user's operation, and starts an application program to transition from a stand-by state to an active state. In addition, the back-end VM 143 detects a user's operation in the same way as the front-end VM 142, and makes the wireless communication unit 111 execute scanning. Then, when confirming that the terminal apparatus 100a stays in the out-of-service area of the wireless LAN 20, the back-end VM 143 performs stop processing of the wireless communication unit 111. Thereby, supplying of the wireless LAN base current to the wireless communication unit 111 is stopped.

According to the terminal apparatus 100a of the fourth embodiment, the consumed power accompanying control of the wireless communication unit 111 is able to be suppressed in the same way as in the second and third embodiments. In addition, even when the OS to perform user interface control and the OS to perform wireless communication control are different, the latter OS is able to recognize release of the stand-by state, and stop processing of the wireless communication unit 111 is able to be executed when the stand-by state is released.

According to the above-mentioned wireless communication apparatus and wireless communication method, a power consumption accompanying control of the wireless communication unit is able to be suppressed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A wireless communication apparatus, comprising:
a wireless communication unit connected to a wireless communication network and configured to perform wireless communication; and
a control unit configured to, when the wireless communication apparatus transitions to a stand-by state without stopping the wireless communication unit and movement from a service area to an out-of-service area in the wireless communication network is detected during the stand-by state, wait for the stand-by state to be released, and to execute stop processing of the wireless communication unit.

2. The wireless communication apparatus according to claim 1, wherein
the control unit controls the wireless communication unit so that the wireless communication unit does not execute searching of an access point of the wireless communication network after a certain period of time has elapsed since the movement to the out-of-service area was detected and until the stand-by state is released.

3. The wireless communication apparatus according to claim 1, wherein
the control unit controls the wireless communication unit so that the wireless communication unit does not execute searching of an access point of the wireless communication network after the movement to the out-of-service area was detected and until the stand-by state is released.

4. A wireless communication apparatus, comprising:
a wireless communication unit connected to a wireless communication network and configured to perform wireless communication; and
a control unit configured to, when the wireless communication apparatus transitions to a stand-by state without stopping the wireless communication unit and a certain period of time has elapsed after the transition to the stand-by state, wait for the stand-by state to be released, and to execute stop processing of the wireless communication unit.

5. The wireless communication apparatus according to claim 4, wherein
the control unit controls the wireless communication unit so that the wireless communication unit does not execute processing to receive a radio signal from an access point of the wireless communication network after the certain period of time has elapsed and until the stand-by state is released.

6. The wireless communication apparatus according to claim 1, further comprising a power controller configured to stop power supply to the wireless communication unit when stop processing of the wireless communication unit is executed.

7. The wireless communication apparatus according to claim 1, wherein
a first operating system which controls a user interface and a second operating system which controls wireless communication are executed,
the control unit, when a stand-by state of the first operating system is released by a user's operation, performs notification to the second operating system, and
the second operating system, based on the notification, executes stop processing of the wireless communication unit.

8. The wireless communication apparatus according to claim 1, wherein
the control unit, when a stand-by state is released, confirms a reception status of a radio signal from the wireless communication network, and executes stop processing of the wireless communication unit in accordance with the reception status.

9. A wireless communication method of an apparatus provided with a wireless communication unit to perform wireless communication, comprising:
transitioning to a stand-by state without stopping the wireless communication unit; and
waiting for the stand-by state to be released and executing stop processing of the wireless communication unit when movement from a service area to an out-of-service area in a wireless communication network has been detected during a stand-by state.
